(19) United States
(12) Patent Application Publication
(10) Pub. No.: US 2014/0327960 A1
(43) Pub. Date: Nov. 6, 2014

(54) MICROSCOPE AND STIMULATING APPARATUS

(71) Applicant: NIKON CORPORATION, Tokyo (JP)

(72) Inventors: Yuki YOSHIDA, Yokohama-shi (JP); Naoki FUKUTAKE, Tokyo (JP)

(21) Appl. No.: 14/298,135

(22) Filed: Jun. 6, 2014

Related U.S. Application Data
(63) Continuation of application No. PCT/JP2012/082584, filed on Dec. 15, 2012.

(30) Foreign Application Priority Data
Dec. 15, 2011 (JP) 2011-274161

(51) Int. Cl. G02B 21/06

(52) U.S. Cl. CPC G02B 21/06
USPC 359/385

(57) ABSTRACT

A scanning microscope includes: a first scanning optical system that irradiates a specimen with light from a first light source via an objective lens to receive light from the specimen; and a second scanning optical system that irradiates the specimen with the light from the first light source or light from a second light source different from the first light source via the objective lens so as to cause the specimen to express a specific phenomenon. The second scanning optical system has a beam shaping optical system that shapes the light from the first light source or the light from the second light source such that a light convergence region on which the light from the first light source or the light from the second light source is collected via the objective lens satisfies a predetermined condition.

### TECHNICAL FIELD

The present invention relates to a microscope and a stimulating apparatus.

### BACKGROUND ART

In observation of a specimen with a microscope, a method is known for observing fluorescence light generated from the specimen by irradiating the specimen with laser light having a predetermined wavelength to stimulate a specific portion thereon, and furthermore, irradiating it with laser light having a different wavelength to excite it. For example, while irradiating spines which are dendrites of the cerebral cortex with laser light allows the spines to be uncaged for fluorescence light observation, uncaging of spines other than on the observation plane against the thickness of the cerebral cortex should allow a wider range of the study thereon. Each of the spines is a projection of approximately 1 μm and a region other than these is not desired to be stimulated with light to as less an extent as possible. The microscope as above brings a range capable of causing a specific phenomenon with laser light (phenomenon arising from the light stimulation as mentioned above) to express to be approximately the depth of focus of an objective lens. Therefore, a configuration of narrowing the diameter of a beam by a beam expander making the diameter of the beam incident on the objective lens variable is disclosed as a method for widening the depth (width in the optical axis direction) of a region undergoing the light stimulation, that is, the depth of focus of the objective lens (for example, refer to Patent Literature

### CITATION LIST

### Patent Literature

[Patent Literature 1] U.S. Pat. No. 7,196,843

### SUMMARY OF INVENTION

### Technical Problem

However, as the diameter of the beam of stimulation light is narrowed to reduce NA, the depth of focus of the objective lens becomes deeper. By doing so, the stimulated region is widened (made deeper) in optical axis direction to some extent, nevertheless, the smaller NA becomes, the larger the spot in the planar direction (in the plane perpendicular to the optical axis) becomes, this having been a problem. If the spot on the stimulation light becomes large as above, a specific spine cannot be stimulated in high precision in observation of brain cells as mentioned above.

The present invention is devised in view of such a problem, and an object of the present invention is to provide a microscope and a stimulating apparatus capable of stimulating a deeper region than in the past with light in a simple configuration.

### Solution to Problem

In order to solve the problem, a microscope according to the present invention includes: a first optical system that irradiates a specimen with light from a first light source via an objective lens to receive light from the specimen; and a second optical system that irradiates the specimen with the light from the first light source or light from a second light source different from the first light source via the objective lens so as to cause the specimen to express a specific phenomenon, wherein the second optical system has a beam shaping optical system that shapes the light from the first light source or the light from the second light source such that a light convergence region on which the light from the first light source or the light from the second light source is collected via the objective lens satisfies the following condition:

$$Δ D > \frac{λ}{2 ( 1 - \sqrt{1 - {NA}^{2}} )} \qquad [ Expression 1 ]$$

where
ΔD represents the maximum distance of the light convergence region of the light from the first light source or the light from the second light source,
λ represents the wavelength of the light from the first light source or the light from the second light source, and
NA represents the numerical aperture of the objective lens.

Herein, the light convergence region is a region which has intensity 80% or more of the maximum intensity when the region, on which the light is collected, is continuous. It is the entirety of the lines connecting the centers of the regions (entirety of the lines connecting the centers of the light convergence points when the regions are the light convergence points) when the region, on which the light is collected, is intermittent.

In the microscope as above, it is preferable that the beam shaping optical system shapes the light such that the light from the first light source or the light from the second light source is collected via the objective lens to be two light beams which are apart from each other by a predetermined distance and form a predetermined angle relative to each other in a predetermined cross-section containing an optical axis of the second optical system.

Moreover, in the microscope as above, it is preferable that the beam shaping optical system shapes the light in regard to its shape in a plane perpendicular to the optical axis such that the light from the first light source or the light from the second light source passes through a region apart from the optical axis by a predetermined distance in a pupil of the objective lens to be collected via the objective lens.

Moreover, in the microscope as above, it is preferable that the beam shaping optical system shapes the light in regard to its shape in the plane perpendicular to the optical axis into an annular belt shape.

Moreover, in the microscope as above, it is preferable that the beam shaping optical system includes two conical lenses arranged such that apexes of the conical lenses face each other.

Moreover, in the microscope as above, it is preferable that the beam shaping optical system includes two conical lenses arranged such that apexes of the conical lenses are in reverse orientations to each other.

Moreover, in the microscope as above, it is preferable that the beam shaping optical system includes a concave conical lens whose conical surface is formed into a mortar-like shape and a convex conical lens in which whose conical surface is disposed to face the conical surface.

Moreover, in the microscope as above, it is preferable that an outer diameter of the annular belt-shaped light is varied by varying a spacing between the conical lenses in an optical axis direction.

Moreover, in the microscope as above, it is preferable that the beam shaping optical system has a concave conical mirror on which a conical surface which reflects the light is formed into a mortar-like shape and in which a through hole is formed on the optical axis and a convex conical mirror on which a conical surface which reflects the light is formed and which is disposed such that its position is coordinated with a position of the through hole, and is configured to allow the light from the light source to pass through the through hole, to be reflected on the convex conical mirror, and furthermore, to be reflected on the concave conical mirror.

Moreover, in the microscope as above, it is preferable that an outer diameter of the annular belt-shaped light is varied by varying a spacing between the conical mirrors in an optical axis direction.

Moreover, in the microscope as above, it is preferable that the beam shaping optical system includes a conical lens, a planar mirror that reflects the light having passed through the conical lens, and furthermore, allows it to incident on the conical lens, and an optical path switching member that guides the light from the light source to the conical lens and guides the light from the conical lens to the specimen, in this order from a light source side.

Moreover, in the microscope as above, it is preferable that an outer diameter of the annular belt-shaped light is varied by varying a spacing between the conical lens and the planar mirror in an optical axis direction.

Moreover, in the microscope as above, it is preferable that a beam expander that is disposed between the first light source or the second light source and the beam shaping optical system or between the beam shaping optical system and the objective lens, and varies an annular belt width of the annular belt-shaped light by varying a diameter of the light is included.

Moreover, in the microscope as above, it is preferable that the beam shaping optical system gives a phase difference between a part, in the light, of any one of the light from the first light source and the light from the second light source and at least part in a rest of the light and forms a plurality of light convergence points on an optical axis of the objective lens via the objective lens.

Moreover, in the microscope as above, it is preferable that the beam shaping optical system has a plurality of light transmissive parts that allow the light to pass through and gives, to the light having passed through at least one light transmissive part of the light transmissive parts, a phase difference between it and the light having passed through the other light transmissive part.

Moreover, in the microscope as above, it is preferable that the beam shaping optical system is a plate-shaped member and is formed such that optical light path lengths of the light for the respective light transmissive parts are different from one another.

Moreover, in the microscope as above, it is preferable that the beam shaping optical system is a spatial light modulator element and optical light path lengths of the light for the respective light transmissive parts are arbitrarily switchable.

Moreover, in the microscope as above, it is preferable that the light transmissive parts have respective incident surfaces on which the light is incident and areas of the incident surfaces are configured such that incident light amounts on the respective incident surfaces are equal to one another.

Moreover, in the microscope as above, it is preferable that an input unit that a dimension of the light convergence region on which the light is collected via the objective lens is inputted to and a controller that controls the beam shaping optical system in accordance with the dimension of the light convergence region are included.

Moreover, in the microscope as above, it is preferable that an input unit that a dimension of the light convergence region on which the light is collected via the objective lens is inputted to and a controller that performs control of at least one of a conical lens position and a conical mirror position in accordance with the dimension of the light convergence region are included.

Moreover, in the microscope as above, it is preferable that an input unit that a dimension of the light convergence region on which the light is collected via the objective lens is inputted to and a controller that performs control of a position of the conical lens and a position of the planar mirror in accordance with the dimension of the light convergence region are included.

Moreover, in the microscope as above, it is preferable that an input unit that a dimension of the light convergence region on which the light is collected via the objective lens is inputted to and a controller that controls the beam expander in accordance with the dimension of the light convergence region are included.

Moreover, in the microscope as above, it is preferable that an input unit that a dimension of the light convergence region on which the light is collected via the objective lens is inputted to and a controller that controls the plate-shaped member in regard to its switching or controls the spatial light modulator element in accordance with the dimension of the light convergence region are included.

Moreover, a stimulating apparatus according to the present invention is attached to a microscope including a light collecting optical system that irradiates a specimen with excitation light via an objective lens and collects fluorescence light generated from the specimen, and includes: a stimulating optical system that irradiates the specimen via the objective lens with light from a first light source that has radiated the excitation light or light from a second light source different from the first light source so as to cause the specimen to express a specific phenomenon, wherein the stimulating optical system has a beam shaping optical system that shapes the light from the first light source or the light from the second light source such that a light convergence region on which the light from the first light source or the light from the second light source is collected via the objective lens satisfies the following condition:

$$Δ D > \frac{λ}{2 ( 1 - \sqrt{1 - {NA}^{2}} )} \qquad [ Expression 2 ]$$

where
ΔD represents the maximum distance of the light convergence region of the light from the first light source or the light from the second light source,
λ represents the wavelength of the light from the first light source or the light from the second light source, and
NA represents the numerical aperture of the objective lens.

### Advantageous Effect of Invention

According to the present invention, a microscope and a stimulating apparatus can be provided capable of stimulating a deeper region than in the past with light in a simple configuration.

### BRIEF DESCRIPTION OF DRAWINGS

FIG. 1 is a descriptive diagram illustrating a configuration of a scanning microscope which is one example of a microscope.

FIG. 2 is a descriptive diagram for describing relationship between a region which is excited and a region which is stimulated and an objective lens in a first embodiment. [FIGS. 3A and 3B] FIGS. 3A and 3B are a descriptive diagram illustrating an exemplary configuration of a beam shaping optical system according to the first embodiment. FIG. 3A illustrates a case where convex conical lenses are so disposed that whose apexes face each other. FIG. 3B illustrates a case where the convex conical lenses are so disposed that whose apexes are in reverse orientations to each other.

FIGS. 4A and 4B are a descriptive diagram illustrating an exemplary configuration of the beam shaping optical system according to the first embodiment. FIG. 4A illustrates a case where two conical mirrors are combined. FIG. 4B illustrates a case where convex and concave conical lenses are combined.

FIG. 5 is a descriptive diagram illustrating another exemplary configuration of the beam shaping optical system according to the first embodiment and illustrates a case where one conical lens and planar mirrors are combined.

FIG. 6 is a descriptive diagram for describing NAs of an outer diameter and an inner diameter of annular belt-shaped laser light in the first embodiment.

FIG. 7 is a graph for describing relationship between the normalized NA of an objective lens for annular belt-shaped laser light and the depth of focus thereof in the first embodiment.

FIGS. 8A to 8C are a descriptive diagram illustrating a method for varying the NA of the outer diameter of the annular belt-shaped laser light for the beam shaping optical system in the first embodiment. FIG. 8A illustrates a reference state. FIG. 8B illustrates a state where the NA is made large. FIG. 8C illustrates a state where the NA is made small.

FIGS. 9A and 9B are a descriptive diagram for describing an annular belt width of the annular belt-shaped laser light in varying the diameter of the laser light by a beam expander in the first embodiment. FIG. 9A illustrates the diameter of the light beam incident on the beam shaping optical system being thin. FIG. 9B illustrates the diameter of the light beam incident on the beam shaping optical system being thick.

FIGS. 10A and 10B are a descriptive diagram for describing variations of a cross-sectional shape of the laser light for stimulation in the first embodiment.

FIG. 10A illustrates that the beam shape may be a shape in which the annular belt partly lacks. FIG. 10B illustrates that light rays from a plurality of light sources or divided light rays from one or more light sources may be arranged into an annular belt shape.

FIGS. 11A to 11C are a descriptive diagram illustrating relationship of the cross-sectional shape of the annular belt-shaped laser light relative to a pupil of the objective lens in the first embodiment. FIG. 11A illustrates a case where it substantially coincides with the pupil center of the objective lens. FIG. 11B illustrates a case where it touches the pupil center. FIG. 11C illustrates a case where it is off the pupil center.

FIGS. 12A and 12B are a descriptive diagram illustrating an exemplary configuration of a beam shaping optical system according to a second embodiment. FIG. 12A is a plan view thereof. FIG. 12B is a longitudinal cross-sectional view taken along the line I-I in FIG. 12(a).

FIGS. 13A and 13B are a descriptive diagram for describing the beam shaping optical system according to the second embodiment. FIG. 13A is a descriptive diagram for describing Expression (8). FIG. 13B is a graph illustrating relationship between light intensity of the laser light collected on a specimen and a coordinate on the optical axis.

FIG. 14 is a descriptive diagram schematically illustrating a state where two light convergence points are formed on the optical axis of the objective lens in the second embodiment.

FIG. 15 is a graph illustrating a result of an optical transfer function for one of the above-mentioned two light convergence points.

FIGS. 16A and 16B are a descriptive diagram illustrating an exemplary configuration of a beam shaping optical system for forming three light convergence points on the optical axis. FIG. 16A is a plan view thereof.

FIG. 16B is a longitudinal cross-sectional view taken along the line II-II in FIG. 16A.

FIG. 17 is a descriptive diagram schematically illustrating a state where three light convergence points are formed on the optical axis of the objective lens in the second embodiment.

FIGS. 18A and 18B are a descriptive diagram illustrating a variation of the beam shaping optical system for forming two light convergence points in the second embodiment. FIG. 18A is a plan view thereof. FIG. 18B is a longitudinal cross-sectional view taken along the line in FIG. 18A.

FIGS. 19A and 19B are a descriptive diagram illustrating another variation of the beam shaping optical system for forming two light convergence points in the second embodiment. FIG. 19A is a plan view thereof.

FIG. 193 is a longitudinal cross-sectional view taken along the line IV-IV in FIG. 19A.

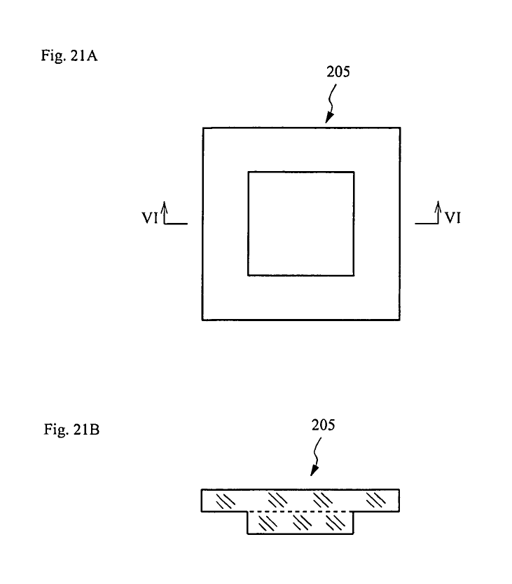

FIGS. 20A and 20B are a descriptive diagram illustrating a variation of the beam shaping optical system for forming three light convergence points in the second embodiment. FIG. 20A is a plan view thereof. FIG. 20B is a longitudinal cross-sectional view taken along the line V-V in FIG. 20A.

FIGS. 21A and 21B are a descriptive diagram illustrating another variation of the beam shaping optical system for forming two light convergence points in the second embodiment. FIG. 21A is a plan view thereof. FIG. 21B is a longitudinal cross-sectional view taken along the line VI-VI in FIG. 21A.

### DESCRIPTION OF EMBODIMENTS

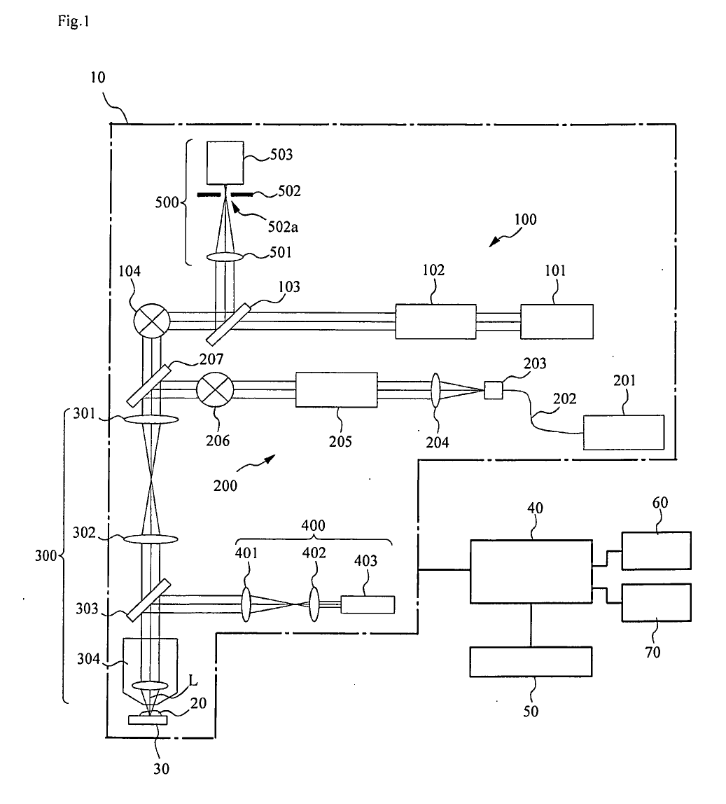

Hereafter, preferred embodiments of the present invention will be described with reference to the drawings. First, a configuration of a scanning microscope 10 which is one example of the microscope is described using FIG. 1. The scanning microscope 10 is configured to have: a first scanning optical system 100 that irradiates a specimen 20 placed on a stage 30 with laser light radiated from a first light source 101 via an objective lens 304 and deflects the laser light to scan the specimen 20; a second scanning optical system 200 that irradiates the specimen 20 with laser light radiated from a second light source 201 via the objective lens 304 and deflects the laser light to scan the specimen 20; an imaging optical system 300 that includes the above-mentioned objective lens 304, collects the laser light having exited out of the first and second scanning optical systems 100 and 200 on the specimen 20 and collects fluorescence light generated from the specimen 20 stimulated and excited with the laser light; and a first detector 400 and a second detector 500 that detect the fluorescence light. Namely, in the scanning microscope 10, the first scanning optical system 100, the imaging optical system 300 and the first and second detectors 400 and 500 constitute a first optical system for observing the specimen 20 on the basis of the fluorescence light generated by irradiating and exciting the specimen 20 with the laser light from the first light source 101, and the second scanning optical system 200 and the imaging optical system 300 constitute a second optical system for causing the specimen 20 to express the specific phenomenon by irradiating the specimen 20 with the laser light from the second light source 201 to stimulate it. Moreover, the second scanning optical system 200 and the imaging optical system 300 also function as a stimulating apparatus which has a stimulating optical system attached to a microscope including the imaging optical system 300 which is a light collecting optical system for irradiating the specimen 20 with excitation light via the objective lens 304 and collecting the fluorescence light generated from the specimen 20. Notably, the light from the first light source 101 instead of the second light source 201 may be collected with the second scanning optical system 200 for irradiation of the specimen 20. Moreover, in the following description, the direction of the optical axis of the imaging optical system 300 is a z-axis and directions which are perpendicular to each other in the plane perpendicular to the z-axis are an x-axis and a y-axis.

The first scanning optical system 100 includes a laser introducing optical system 102, a first optical path splitting member 103 and a first scanning unit 104 in this order from the first light source 101 side. Moreover, the second scanning optical system 200 includes an optical fiber 202, a fiber emitting end 203, a collimator lens 204, a beam shaping optical system 205, a second scanning unit 206 and a second optical path splitting member 207 in this order from the second light source 201 side. Moreover, the imaging optical system 300 includes a pupil projection lens 301, a second objective lens 302, a third optical path splitting member 303 and the objective lens 304 in this order from the side of the light sources.

The first light source 101 radiates very short pulse-like laser light which is for inducing multiphoton excitation of the specimen 20 and exits at a predetermined interval (for example, pulse light with 100 femtoseconds; hereinafter referred to as “IR pulse light” or “excitation light”). The IR pulse light having exited out of the first light source 101 is substantially collimated light, and after passing through the laser introducing optical system 102, passes through the first optical path splitting member 103 to be incident on the first scanning unit 104. Then, the IR pulse light is scanned by the first scanning unit 104 and passes through the second optical path splitting member 207 to be incident on the imaging optical system 300.

Herein, the first optical path splitting member 103 is configured of a dichroic mirror or a half-silvered mirror. Moreover, the first scanning unit 104 two-dimensionally scans the IR pulse light in the directions perpendicular to the optical axis (above-mentioned x-axis direction and y-axis direction). For example, it includes a first deflector element that deflects the IR pulse light in a predetermined direction (x-axis direction) in the plane perpendicular to the optical axis by reflecting the IR pulse light and a second deflector element that deflects this IR pulse light in the direction substantially perpendicular to the predetermined direction (y-axis direction) by further reflecting the IR pulse light having been reflected by the first deflector element.

Moreover, the second light source 201 radiates visible laser light for stimulating the specimen 20 (hereinafter referred to as “visible light” or “stimulating light”). After passing through the optical fiber 202, the visible light radiated from the second light source 201 exits out of the fiber emitting end 203 as light with a distribution, is set to be substantially collimated light by the collimator lens 204 and passes through the beam shaping optical system 205 to be incident on the second scanning unit 206. Then, this visible light is scanned by the second scanning unit 206 and reflected by the second optical path splitting member 207 to be combined with the IR pulse light and to be incident on the imaging optical system 300.

Herein, the second optical path splitting member 207 is also configured of a dichroic mirror or a half-silvered mirror. Moreover, the second scanning unit 206 also two-dimensionally scans the visible light in the directions perpendicular to the optical axis (above-mentioned x-axis direction and y-axis direction). For example, it includes a first deflector element that deflects the visible light in a predetermined direction (x-axis direction) in the plane perpendicular to the optical axis by reflecting the visible light and a second deflector element that deflects this visible light in the direction substantially perpendicular to the predetermined direction (y-axis direction) by further reflecting the visible light having been reflected by the first deflector element.

The IR pulse light and the visible light which have exited out of the second optical path splitting member 207 are once collected with the pupil projection lens 301 before they are set to be substantially collimated light by the second objective lens 302, and pass through the third optical path splitting member 303 to be incident on the objective lens 304 through which they are focused on the specimen 20 placed on the stage 30. Herein, the third optical path splitting member 303 is also configured of a dichroic mirror or a half-silvered mirror. Notably, the deflector elements of the first scanning unit 104 and the second scanning unit 206 are so arranged that they substantially coincide with a pupil image, of the objective lens 304, which is formed by the pupil projection lens 301 or are close to the same individually.

The fluorescence light generated from the specimen 20 by the stimulation with the visible light and the excitation with the IR pulse light is collected with the objective lens 304 and incident on the third optical path splitting member 303.

Fluorescence light with a predetermined wavelength out of the fluorescence light incident on the third optical path splitting member 303 is reflected by the third optical path splitting member 303 to be incident on the first detector 400. The first detector 400 includes a first condenser lens 401, a second condenser lens 402 and a first photoelectric transducer element 403 in this order from the third optical path splitting member 303 side. The fluorescence light reflected by the third optical path splitting member 303 is collected with the first and second condenser lenses 401 and 402, and then incident on the first photoelectric transducer element 403 to be converted into an electric signal.

The fluorescence light reflected by the third optical path splitting member 303 is fluorescence light generated by two-photon excitation with the excitation light. Since the two-photon excitation only arises in the focal plane of the objective lens 304, the first detector 400 is not needed to be provided with a light shielding plate (pinhole). The first detector 400 here is also called a NDD (Non-Descan Detector).

On the other hand, fluorescence light with different wavelengths from the above-mentioned predetermined wavelength out of the fluorescence light incident on the third optical path splitting member 303 passes through the third optical path splitting member 303, passes through the second objective lens 302 and the pupil projection lens 301, and furthermore, passes through the second optical path splitting member 207 to be incident on the first scanning unit 104. Then, this fluorescence light is descanned by the first scanning unit 104 and reflected by the first optical path splitting member 103 to be incident on the second detector 500.

The second detector 500 includes a third condenser lens 501, a light shielding plate 502 disposed at a position substantially conjugate to the focal plane on the specimen side of the objective lens 304, and a second photoelectric transducer element 503 in this order from the first optical path splitting member 103 side. Herein, the light shielding plate 502 is provided with a pinhole 502a and the pinhole 502a is disposed to contain the optical axis. The fluorescence light reflected by the first optical path splitting member 103 is collected on the pinhole 502a of the light shielding plate 502 with the third condenser lens 501, and only the light having passed through the pinhole 502a is detected by the second photoelectric transducer element 503 to be converted into an electric signal.

As mentioned above, the pinhole 502a of the light shielding plate 502 is conjugate to the point image of the laser light (excitation light) collected on the scanning plane on the specimen 20. The fluorescence light having exited out of the irradiation region on the specimen 20 (on the focal plane of the objective lens 304) can pass through the pinhole 502a. On the other hand, most of the light having exited out of the other region on the specimen 20 is not collected on the pinhole 502a not to be able to pass therethrough. Therefore, the resolution in the image of the specimen 20 in the depth direction can be improved.

Moreover, a controller 40 that controls the scanning microscope 10 in regard to its operation is connected to this scanning microscope 10. Furthermore, the controller 40 is provided with an input unit 50 for manipulating the scanning microscope 10, an output unit 60 for displaying a menu for the manipulation and images of the specimen 20 obtained by the first and second photoelectric transducer elements 403 and 503, and a storage unit 70 for storing the images.

Based on the above, the controller 40 processes the optical signal (electric signal) detected by the first or second photoelectric transducer element 403, 503, synchronizing with the scanning of the first and second scanning units 104 and 206. Thereby, a two-dimensional image of the specimen 20 in the scanning plane can be obtained using coordinates, on the specimen 20, where it is irradiated with the laser light and brightnesses obtained based on the optical signal. By doing so, the scanning microscope 10 can afford the image of the specimen 20 in high resolution. Moreover, the scanning microscope 10 can be used as a scanning multiphoton microscope as well as a scanning confocal microscope.

Two embodiments as to the beam shaping optical system 205 disposed in the second scanning optical system 200 with the above-mentioned configuration will be described below.

### First Embodiment

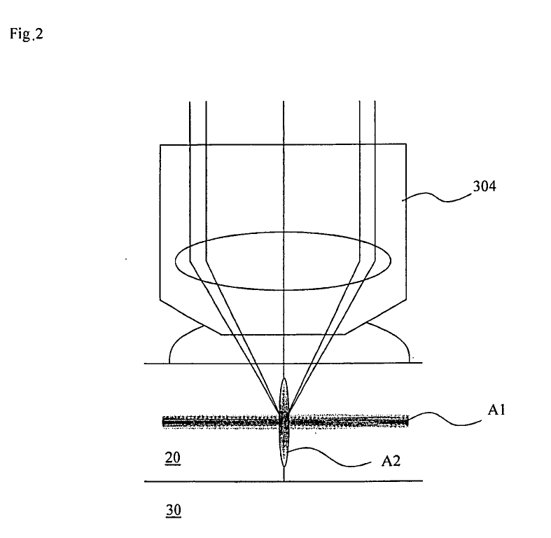

First, the beam shaping optical system 205 according to a first embodiment is described using FIGS. 2 to 11. This beam shaping optical system 205 according to the first embodiment shapes the laser light (stimulating light) which is radiated by the second light source 201 and set to be substantially collimated light into a certain cross-sectional shape (certain shape of the cross-section of the light beam in the plane perpendicular to the optical axis) with the collimator lens 204 such that the laser light is collected with the objective lens 304 after passing at least through a region which is in the pupil of the objective lens 304 and is apart from the optical axis by a predetermined distance. In other words, the laser light (stimulating light) shaped by the beam shaping optical system 205 is constituted of two light beams which have a predetermined angle with respect to the optical axis in its cross-section in a predetermined plane including the optical axis, and is collected via the objective lens 304. Such a cross-sectional shape of the laser light includes an annular band shape surrounding the optical axis. Hereafter, the beam shaping optical system 205 is described which shapes the laser light into the annular band shape.

The laser light is so shaped in regard to the cross-sectional shape that it passes at least through a region which is in the pupil of the objective lens 304 and is apart from the optical axis by a predetermined distance. Then, the light is collected on the focal plane of the objective lens 304 from a periphery part of the objective lens 304 (region apart from the optical axis by a predetermined distance). Collecting the laser light from the periphery part of the objective lens 304 as above allows the width (depth) in the optical axis direction in the region stimulated with this laser light, that is, the depth of focus of the objective lens 304 to be deep. In particular, when the cross-sectional shape of the laser light is set to be the annular belt shape by the beam shaping optical system 205, the laser light collected with the objective lens 304 affords a Bessel beam whose intensity distribution in the radius direction in the cross-section is represented by the Bessel function of the first kind, allowing its depth of focus to be exceedingly deep. In other words, the stimulating light deeper in the optical axis direction (depth direction) is formed (stimulating light spreading in the depth direction is formed). In FIG. 2, the plane on which the first scanning optical system 100 performs the focusing for observation is designated by reference sign A1 and the region stimulated with the Bessel beam from the second scanning optical system 200 (light convergence region) is designated by reference sign A2. Thus, while the plane A1 is observed with the first scanning optical system 100, a region which spreads deeper in the optical axis direction, including a small and narrow region in the observation plane, can be stimulated with the Bessel beam formed by the second scanning optical system 200. As a result, the scanning microscope 10 is suitable for observing brain cells as mentioned above.

FIG. 3A illustrates one exemplary configuration of the beam shaping optical system 205 shaping substantially collimated laser light (visible light or stimulating light) into an annular belt shape in regard to its cross-sectional shape. This beam shaping optical system 205 has two transmissive convex conical lenses (axicon lenses) 205a and 205b which are so arranged that their apexes face each other. Notably, FIGS. 3A and 3B illustrates a case where the laser light having exited out of the second light source 201 travels from the left to the right. Configuring the beam shaping optical system 205 as above allows the substantially collimated laser light from the second light source 201 to be converted into dispersing annular belt-shaped laser light with the first conical lens 205a and further to be converted into substantially collimated annular belt-shaped laser light with the second conical lens 205b. Notably, as illustrated in FIG. 3B, even arranging the first and second conical lenses 205a and 205b with their apexes being in reverse orientations to each other can also afford the annular belt-shaped laser light similarly to FIG. 3A.

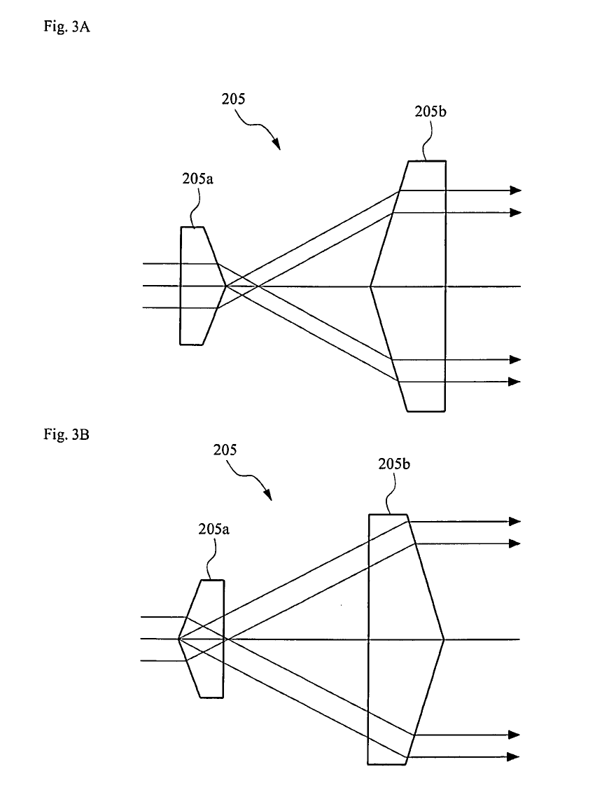

Moreover, as illustrated in FIG. 4A, a convex first conical mirror 215a arranged with its apex facing the light source side is combined with a concave second conical mirror 215b in whose region containing the optical axis a through hole is formed and in the periphery of which hole a mortar-like conical surface is formed as a reflective surface. This also allows the laser light to be shaped into an annular belt shape in regard to its cross-sectional shape. In this case of the configuration of FIG. 4A, the substantially collimated laser light from the second light source 201 passes through the through hole of the second conical mirror 215b to be incident on the reflective surface of the first conical mirror 215a. Then, the laser light reflected on the reflective surface of the first conical mirror 215a is converted into dispersing annular belt-shaped laser light, furthermore, is incident on the reflective surface of the second conical mirror 215b and is reflected on this reflective surface to be converted into the substantially collimated annular belt-shaped laser light.

Moreover, as illustrated in FIG. 4B, a transmissive concave first conical lens 225a on which a mortar-like conical surface is formed and a convex second conical lens 225b are arranged with their apexes face the light source side. This also allows the laser light to be shaped into the annular belt shape in regard to its cross-sectional shape. In this case of FIG. 4B, the substantially collimated laser light from the second light source 201 is converted into dispersing annular belt-shaped laser light on the mortar-like conical surface of the first conical lens 225a, and furthermore, is converted into the substantially collimated annular belt-shaped laser light with the second conical lens 225b.

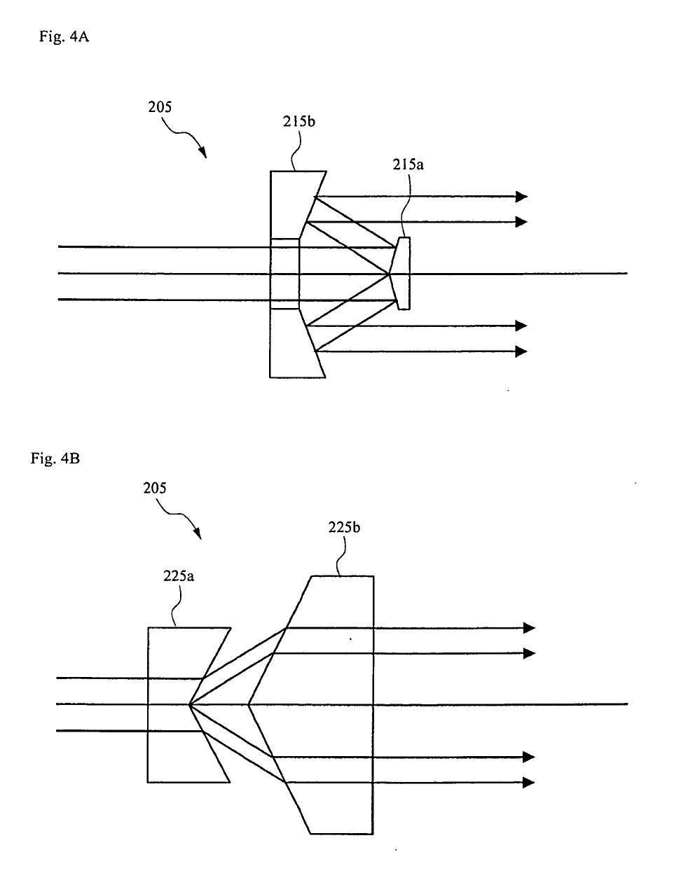

Moreover, as illustrated in FIG. 5, combining a transmissive convex conical lens 235a whose apex faces the specimen side with a planar mirror 235b reflecting the laser light having passed through the conical lens 235a also allows the laser light to be shaped into an annular belt shape in regard to its cross-sectional shape. In this case of FIG. 5, a hollow mirror 235c which inclines with respect to the optical axis (for example, inclines by 45 degrees) is disposed on the light source side of the conical lens 235a. The substantially collimated laser light from the second light source 201 passes through the hollow part of the hollow mirror 235c to be incident on the conical lens 235a and to be converted into dispersing annular belt-shaped laser light with the conical lens 235a. Then, it is reflected by the planar mirror 235b again to be incident on the conical lens 235a and to be converted into the substantially collimated annular belt-shaped laser light, which is reflected by the hollow mirror 235c to exit. In this way, combining one conical lens 235a with one planar mirror 235b can configure the beam shaping optical system 205 of one conical lens, which is expensive. Moreover, disposing the hollow mirror 235c enables the hollow mirror 235c to function as an optical path switching member and the incident light with respect to the beam shaping optical system 205 to be separated from the exiting light.

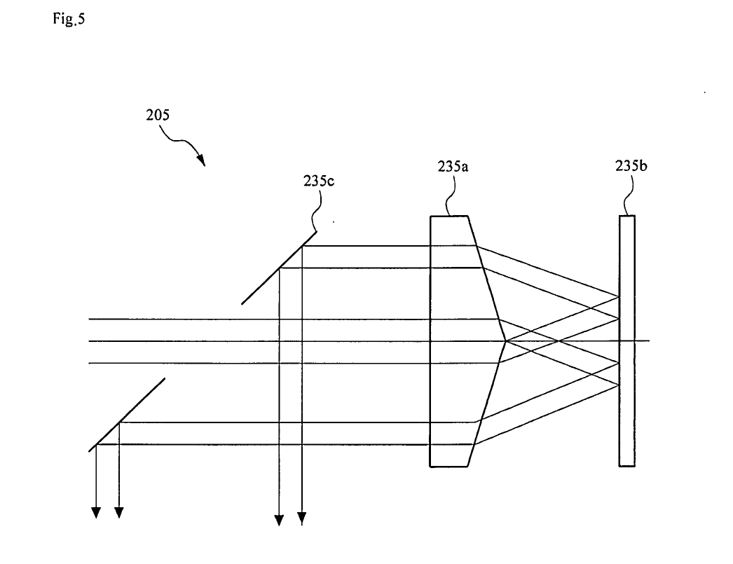

The laser light (Bessel beam) shaped by the beam shaping optical system 205 as above has an annular belt-like pupil shape IA as illustrated in FIG. 6. Herein, supposing that the numerical aperture of the outer diameter and the numerical aperture of the inner diameter of the annular belt-like pupil shape IA are NA and NA′, respectively, wavefront aberrations φ with respect to the numerical apertures NA and NA′ are represented by Expressions (1) and (2) below. Notably, in Expressions (1) and (2) below, λ represents a wavelength and Δz represents a defocus amount.

$$\begin{matrix}[ Expression 3 ] & \\ φ ( NA ) = \frac{2 π}{λ} Δ z ( 1 - \sqrt{1 - {NA}^{2}} ) & ( 1 ) \\ φ ( {NA}^{′} ) = \frac{2 π}{λ} Δ z ( 1 - \sqrt{1 - {NA}^{′2}} ) & ( 2 )\end{matrix}$$

Moreover, supposing that a wavefront aberration of the above-mentioned annular belt-shaped laser light (Bessel beam) illustrated in FIG. 6 is Δφ, it is as in Expression (3) below since it is represented as the difference between Expressions (1) and (2) above.

$$\begin{matrix}[ Expression 4 ] & \\ Δφ = \frac{2 π}{λ} Δ z ( \sqrt{1 - {NA}^{2}} - \sqrt{1 - {NA}^{′2}} ) & ( 3 )\end{matrix}$$

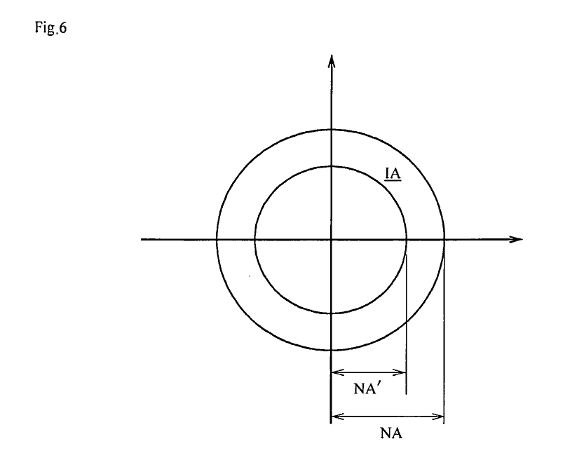

Herein, it is supposed that a region in which defocusing causes up to λ/4 of wavefront aberration corresponds to the depth of focus of the Bessel beam and that this range of the depth of focus is a region where the specimen 20 can be stimulated with the laser light. Then, relationship between the numerical aperture of the Bessel beam and the depth of focus is as in FIG. 7 on the basis of Expression (3) mentioned above. Notably, in FIG. 7, the horizontal axis indicates normalized NA, that is, the value having the numerical aperture NA′ of the inner diameter of the Bessel beam divided by the numerical aperture NA of the outer diameter thereof, and the vertical axis indicates a depth of focus of the objective lens 304 for the Bessel beam (depth of focus from the focal plane for the Bessel beam on the light source side or the specimen side). Notably, in calculating the graphs illustrated in FIG. 7, it is supposed that the objective lens 304 is a liquid immersion objective lens and the refractive indices of both the specimen 20 and the immersion liquid are 1.35. Moreover, it is supposed that the wavelength of the laser light is 0.405 μm. Moreover, the graphs in FIG. 7 represent varying the numerical aperture NA of the outer diameter of the Bessel beam from 0.1 to 1.3 at an interval of 0.1. The uppermost line indicates the case of NA=0.1 and the lowermost line indicates the case of NA=1.3.

As above, based on NA of the outer diameter of the beam shape in the laser light that is shaped by the beam shaping optical system 205, the diameter of the spot on which the light is collected with the objective lens 304 is determined. Moreover, based on NA of the outer diameter and normalized NA (=NA′/NA), the depth of focus can be determined.

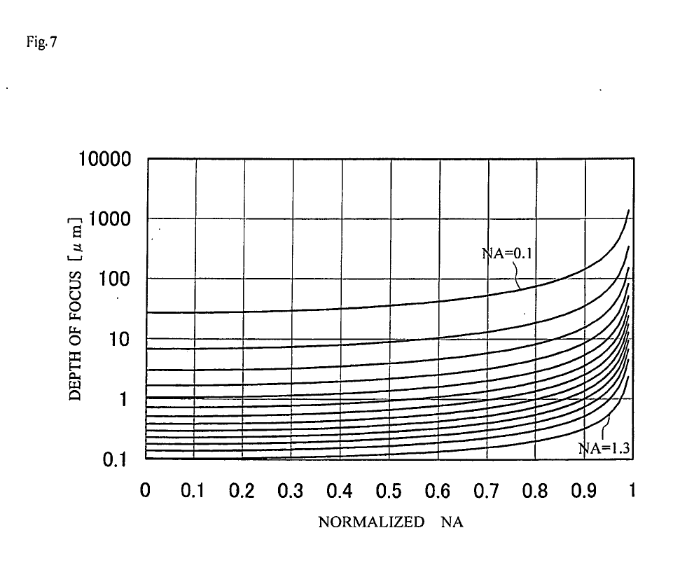

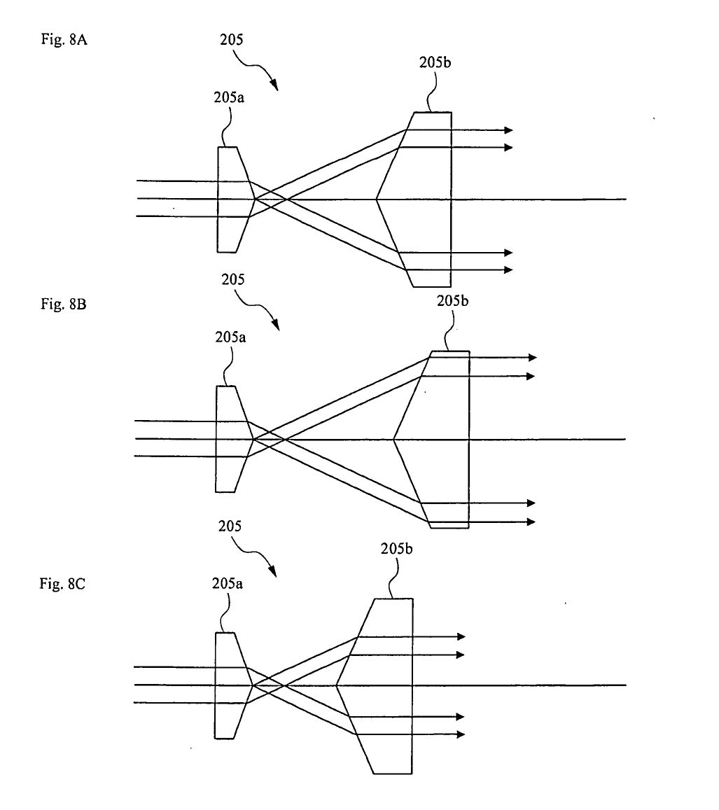

Notably, as illustrated in FIG. 8, varying the spacing between the first and second conical lenses 205a and 205b in the optical axis direction enables NA of the outer diameter of the annular belt-shaped laser light to be varied. Moreover, as illustrated in FIG. 9, a beam expander 208 is disposed on the light source side of the beam shaping optical system 205 and the diameter of the light beam incident on the beam shaping optical system 205 is varied. This enables the annular belt width of the annular belt-shaped laser light to be varied. Namely, NA of the outer diameter of the annular belt-shaped laser light can be made larger as the spacing between the first and second conical lenses 205a and 205b is made wider and NA of the outer diameter thereof can be made smaller as the spacing therebetween is made narrower. Moreover, the annular belt width can be made narrower as the diameter of the light beam incident on the beam shaping optical system 205 is made thinner by the beam expander 208 and the annular belt width can be made wider as the diameter of the light beam is made thicker. The same holds true for the configuration of combining the conical lenses 225a and 225b or the conical mirrors 215a and 215b and the configuration of combining the conical lens 235a and the planar mirror 235b.

The scanning microscope 10 according to the embodiment can stimulate a desired region of the specimen 20 with the laser light by providing an actuator, in the beam shaping optical system 205, for moving the position of the above-mentioned conical lens, conical mirror or planar mirror in the optical axis direction and performing control of its operation with the controller 40. Moreover, the same holds true for performing control of the diameter of the light beam having exited out of the beam expander 208 with the controller 40. In this case, the dimension of the light convergence region in which the laser light from the second light source 201 is collected via the objective lens 304 is set in the controller 40 using the input unit 50 and the controller 40 controls the actuator of the beam shaping optical system 205 or the beam expander 208 mentioned above in regard to its operation. This allows the configuration of stimulating (illuminating) the light convergence region thus set. Notably, control amounts in controlling the beam shaping optical system 205 or the beam expander 208 in regard to its operation (for example, defocus amount Δz) may be obtained by calculation in controller 40 using the above-mentioned expressions and the like or on the basis of relation between those beforehand stored in the storage unit 70 as a table, the controller 40 reading out values of those.

Based on Expression (3) mentioned above, the distance ΔD of the light convergence region of the stimulating light in the optical axis direction, in other words, the distance of the region which has intensity 80% or more of the maximum intensity of the collected light in the optical axis direction is as in Expression (4) below, where the wavelength of the laser light is λ. Notably, the distance of the region which has intensity 80% or more of the maximum intensity of the collected light in the optical axis direction, in other words, is also a distance in the optical axis direction from the position which has the intensity 80% of the maximum intensity on the light source side to the position which has the intensity 80% of the maximum intensity on the opposite side to the light source, the focal plane of the objective lens 304 affording the center between these.

$$\begin{matrix}[ Expression 5 ] & \\ Δ D = \frac{λ}{2 ( \sqrt{1 - {NA}^{′2}} - \sqrt{1 - {NA}^{2}} )} & ( 4 )\end{matrix}$$

For example, ΔD=1.99 μm when NA=0.9, NA′=0.88, λ=488 nm.

On the other hand, when the beam expander allows the diameter of the beam incident on the objective lens 304 to be variable, the distance of the light convergence region of the stimulating light in the optical axis direction, in other words, the distance ΔDS of the region which has intensity 80% or more of the maximum intensity of the collected light in the optical axis direction is as in Expression (5) below.

$$\begin{matrix}[ Expression 6 ] & \\ Δ DS = \frac{λ}{2 ( 1 - \sqrt{1 - {NA}^{2}} )} & ( 5 )\end{matrix}$$

For example, ΔDS=0.43 μm when NA=0.9.

Herein, considering the relationship in Expression (6) below, the distance ΔD of the light convergence region in the optical axis direction, represented by Expression (4), is in the relationship of Expression (7) below.

$$\begin{matrix}[ Expression 7 ] & \\ \frac{λ}{2 ( \sqrt{1 - {NA}^{′2}} - \sqrt{1 - {NA}^{2}} )} > \frac{λ}{2 ( 1 - \sqrt{1 - {NA}^{2}} )} & ( 6 ) \\ Δ D > \frac{λ}{2 ( 1 - \sqrt{1 - {NA}^{2}} )} & ( 7 )\end{matrix}$$

Notably, when the objective lens 304 with immersion liquid is a liquid immersion objective lens, supposing that the refractive index of the immersion liquid is n, λ is needed to be replaced by λ/n and NA to be replaced by NA/n in Expressions (4) to (7) above.

Moreover, as to the distances ΔD and ΔDS of the light convergence region of the stimulating light in the optical axis direction, since the center of the beam incident on the objective lens 304 substantially coincides with the optical axis and the distance in the optical axis direction is the maximum distance, the distance in the optical axis direction equals to the maximum distance. When the center of the beam incident on the objective lens 304 does not substantially coincide with the optical axis, the distance in the optical axis direction is not the maximum distance. Hence, it is needed to be replaced by the maximum distance of the light convergence region of the stimulating light.

Moreover, in the description above, the case where the laser light for observation (excitation light) is IR pulse light and the laser light for stimulation (stimulating light) is visible light is described. The excitation light may be visible light and the stimulating light be IR pulse light. Both of them may be visible light or both of them be IR pulse light. For example, in a case where brain cells are the specimen 20, when the excitation light is visible light, only a shallow part thereof can be excited (observed). Setting the stimulating light to be IR pulse light can allow a deeper part thereof to be stimulated. Moreover, when the excitation light and the stimulating light are IR pulse light, even a deeper part of the specimen 20 can be excited (observed) and stimulated. Moreover, in the description above, the case where only the second scanning optical system 200 is provided with the beam shaping optical system 205 is described. The beam shaping optical system can be provided also in the first scanning optical system 100. Moreover, when the specimen 20 is stimulated on the sides of a different plane, as the center, from the focal plane of the objective lens 304, an optical system may be provided in the second scanning optical system 200, for adjusting the imaging position such that the center of light collection of the stimulating light is shifted toward the specimen or toward the light source relative to the focal plane of the objective lens 304 (for example, an optical system is provided for collecting the stimulating light, which is substantially collimated light, closer to the specimen or the image relative to the focal plane of the objective lens 304 with divergence or convergence to some extent). Of course, the beam shaping optical system above can be applied to an optical system for stimulating light in any other microscope as well as the above-mentioned scanning microscope 10.

Moreover, in the description above, the case where the beam expander 208 is disposed on the light source side of the beam shaping optical system 205 disposed in the second scanning optical system 200, that is, between the beam shaping optical system 205 and the second light source 201 (fiber emitting end 203) is described. The beam expander 208 may be disposed on the specimen side of the beam shaping optical system 205, that is, between the beam shaping optical system 205 and the objective lens 304. Moreover, also when the beam shaping optical system is provided in the first scanning optical system 100, the beam expander may be disposed between the beam shaping optical system and the first light source 101 or between the beam shaping optical system and the objective lens 304.

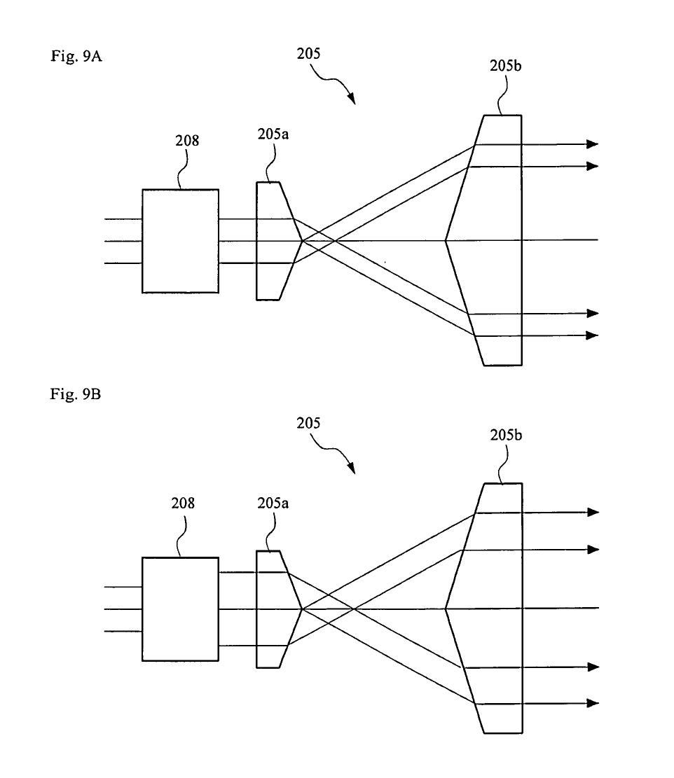

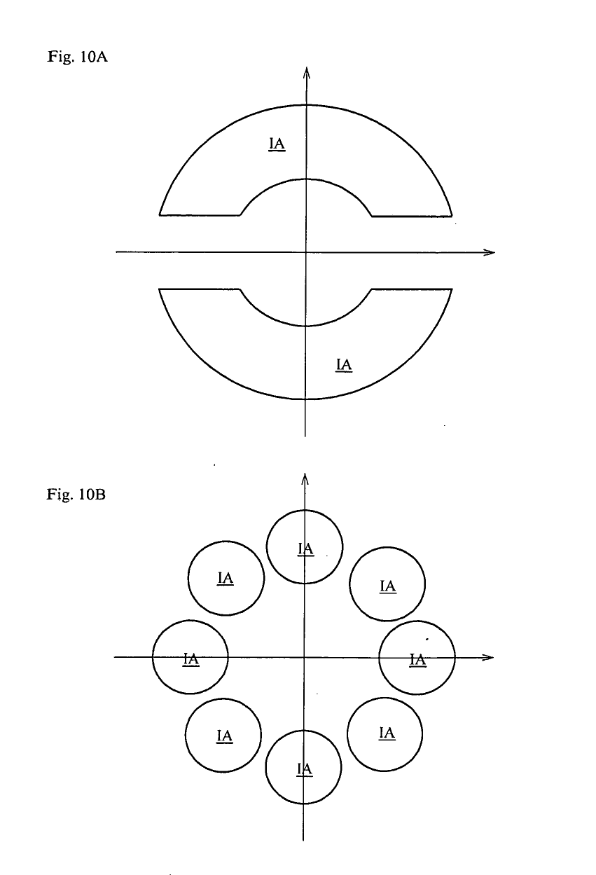

Moreover, in the description above, the case where the visible light (stimulating light) is converted into annular belt-shaped laser light (Bessel beam) is described. As illustrated in FIG. 10A, its beam shape IA may be a shape in which the annular belt partly lacks. Moreover, as illustrated in FIG. 10B, light rays from a plurality of light sources or divided light rays from one or more light sources may be arranged into an annular belt shape. In any of the examples in FIGS. 10A and 10B, the laser light (stimulating light) shaped by the beam shaping optical system 205 is constituted of two light beams which have a predetermined angle with respect to the optical axis in its cross-section in a predetermined plane including the optical axis. Moreover, the beam shaping optical system 205 may employ an aperture stop in which an annular belt-shaped opening part is formed without using the conical lens or the conical mirror to be disposed.

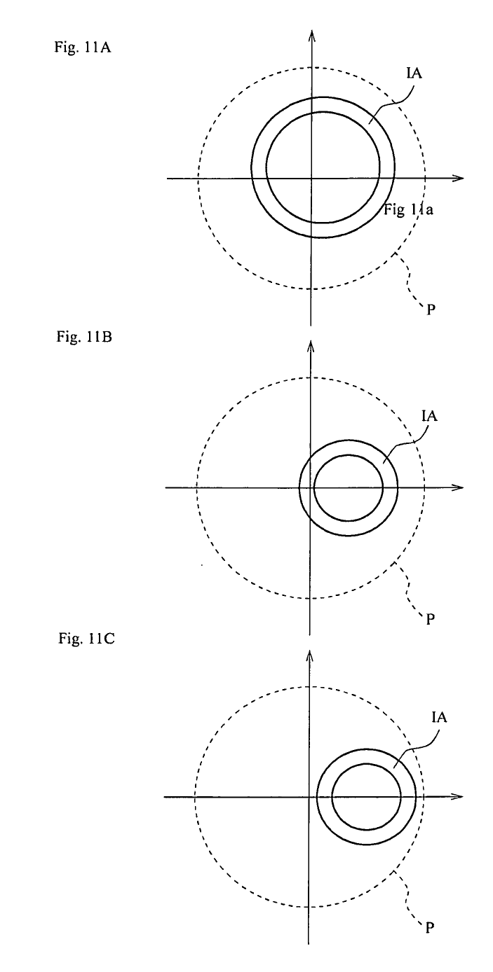

Moreover, as to the laser light shaped by the beam shaping optical system 205, its annular belt-like pupil shape IA may substantially coincide with the center of the pupil P of the objective lens 304 as illustrated in FIG. 11A, or it may touch the center of the pupil P thereof as illustrated in FIG. 11B, or it may be off the center of the pupil P thereof as illustrated in FIG. 11C.

### Second Embodiment

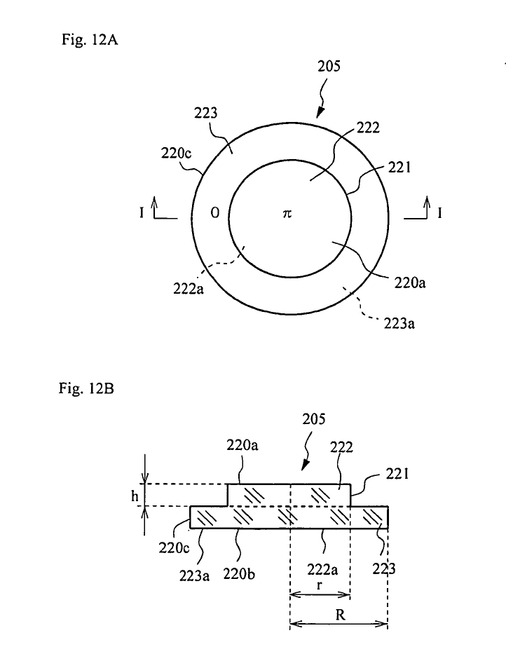

Next, a configuration of the beam shaping optical system 205 according to a second embodiment is described using FIGS. 12 to 21. This beam shaping optical system 205 according to the second embodiment is configured as a disc-shaped optical member as illustrated in FIG. 12. On one surface 220a of the beam shaping optical system 205, a step part 221 is formed which is open to a circumferential surface 220c of the beam shaping optical system 205 and extending in the circumferential direction of the beam shaping optical system 205 as illustrated in a plan view of FIG. 12A and a longitudinal cross-sectional view of FIG. 12B. A depth dimension h of the step part 221 is configured to satisfy the relationship h(n−1)=λ/2, where the refractive index of a glass base plate is n and the wavelength of the laser light is λ. Accordingly, for example, h=488 nm when the wavelength λ, of the laser light, =488 nm and the refractive index n=1.5. Moreover, the step part 221 can be formed, for example, using a conventionally well-known lithography technique. Formation of the step part 221 allows a circular cylinder-shaped first light transmissive part 222 to be formed in the center part of the beam shaping optical system 205 and an annular second light transmissive part 223 having a plate thickness dimension smaller than the plate thickness dimension of the first light transmissive part 222 to be formed in the circumferential edge part of the beam shaping optical system 205.

The first and second light transmissive parts 222 and 223 have incident surfaces 222a and 223a on which the laser light is incident, respectively. The dimensions of the incident surfaces 222a and 223a are so configured that incident light amounts on the relevant incident surfaces are equal to each other. In the example of the figure, supposing that the other surface 220b, of the beam shaping optical system 205, which is constituted of the incident surfaces 222a and 223a is uniformly irradiated with the laser light, the step part 221 is so formed that the areas of the incident surfaces 222a and 223a are equal to each other. Namely, when the radius of the other surface 220b of the beam shaping optical system 205 is R and the radius of the first light transmissive part 222 is r, R and r satisfy the relationship R=R·2^{1/2}.

When the beam shaping optical system 205 is irradiated with the laser light (stimulating light) on the other surface 220b side, one half of the laser light passes through the first light transmissive part 222 and the rest half of the laser light passes through the second light transmissive part 223. In this stage, the depth dimension h of the step part 221 satisfies the relationship h(n−1)=λ/2 as mentioned above. Hence, a phase difference π is given between the laser light rays having passed through the first and second light transmissive parts 222 and 223. The two laser light rays subject to the phase difference pass through the second scanning unit 206 and the second optical path splitting member 207, and are then converted into spherical waves with the objective lens 304 to be collected toward the specimen 20. Notably, FIG. 12 exemplarily shows the phase differences “0” and “π”, which may be replaced conversely.

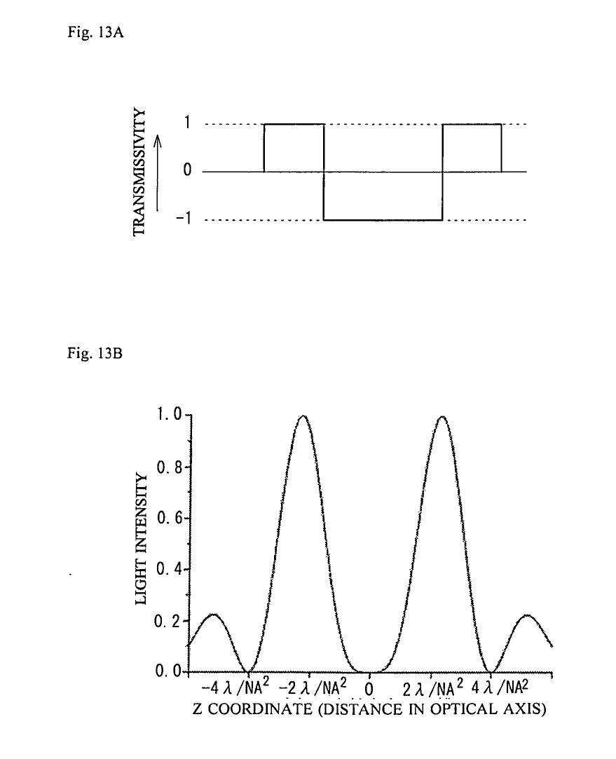

The intensity of the laser light on the optical axis L of the objective lens 304 in this stage is represented by Expression (8) below. In Expression (8), NA is the numerical aperture of the objective lens 304. Expression (8) is an approximate expression with small NA and indicates light intensity distribution, on the optical axis, of the laser light having passed through a phase mask with the transmissivity represented in FIG. 13A, and then having been collected with the objective lens (refer to: M. Born and E. Wolf, Principles of Optics (5th. ed, Pergamon Press, 1974)).

$$\begin{matrix}[ Expression 8 ] & \\ I ( 0 , 0 , z ) = {[ \frac{sin [ \frac{π}{2 λ} {NA}^{2} z ]}{\frac{π}{2 λ} {NA}^{2} z} - \frac{sin [ \frac{π}{4 λ} {NA}^{2} z ]}{\frac{π}{4 λ} {NA}^{2} z} ]}^{2} & ( 8 )\end{matrix}$$

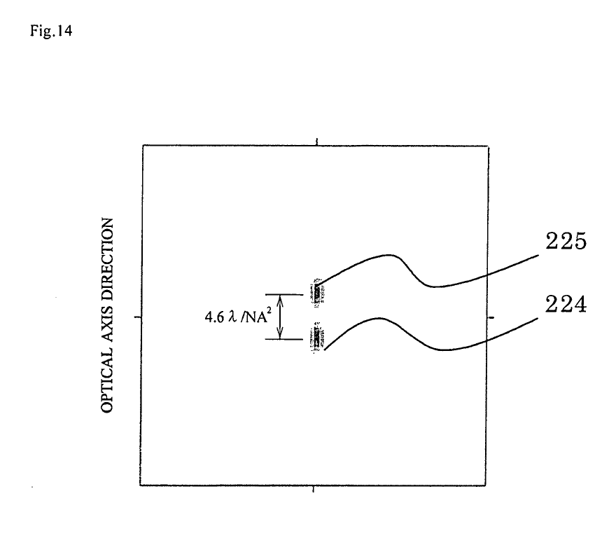

FIG. 13B is a graph plotting Expression (8). In the graph of FIG. 13B, the vertical axis indicates the light intensity of the laser light and the horizontal axis indicates the coordinate on the optical axis L. As apparent from FIG. 13B, two peaks whose light intensities are at their maximums present in front of and behind the geometric optical focal point of the objective lens 304 on the optical axis L. Namely, when two laser light rays different in phase from each other pass through the objective lens 304, two light convergence points 224 and 225 whose values of light intensities are at their maximums are formed on the optical axis L as illustrated in FIG. 14. In the example of the figure, the spacing between both light convergence points 224 and 225 is 4.6λ/NA² when NA is small, for example, NA<0.3, where the wavelength of the laser light is λ and the numerical aperture of the objective lens 304 is NA. The spacing between both light convergence points 224 and 225 is approximately 2λ when NA is large, for example, NA=0.9. Accordingly, when λ=488 nm, for example, the spacing between both light convergence points 224 and 225 is approximately 1 μMm. Notably, when NA is large, Expression (8) is not completed but the spacing between both light convergence points 224 and 225 is approximately 2λ/NA². Namely, supposing the spacing between both light convergence points 224 and 225 (distance between the centers of the light convergence points) as being d, relationship in Expression (9) below is completed.

d=A(NA)×λ/NA² (9)

It should be noted that A(NA) is a coefficient of proportionality and a function of NA, and A(NA) has the value 4.6 when NA is small, the value 2 when NA is large and a value between 2 and 4.6 when NA is medium. In other words, the range of the coefficient of proportionality A(NA) is 2≦A(NA)≦4.6.

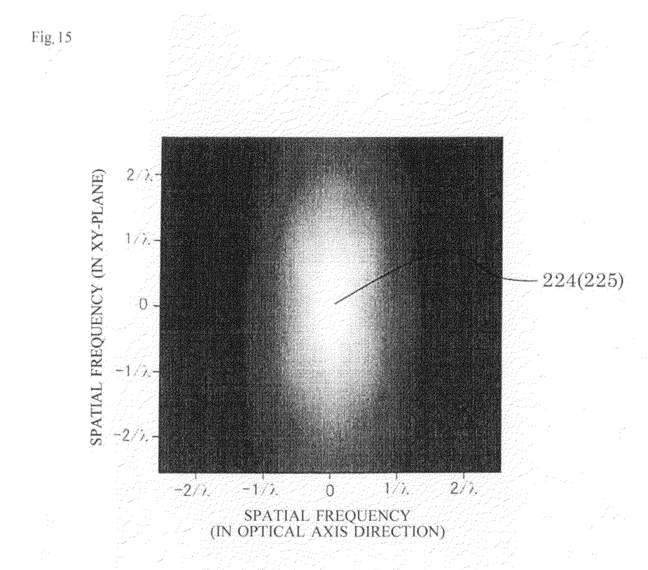

Moreover, optical transfer functions (Optical Transfer Functions: hereinafter referred to as OTFs) corresponding to the light convergence points 224 and 225 are substantially equivalent to each other. FIG. 15 illustrates the result of an OTF for one of the light convergence points 224 and 225. In FIG. 15, the vertical axis indicates a spatial frequency in the XY-plane and the horizontal axis indicates a spatial frequency in the optical axis direction. As apparent from FIG. 15, sufficient depth resolution is clearly shown. The depth resolution is performance of resolution for a three-dimensional lattice with a lattice vector in the optical axis direction as conventionally well known.

The specimen 20 is irradiated with the laser light rays having passed through the objective lens 304. Notably, the light convergence points 224 and 225 are scanned by the second scanning unit 206 also in the second embodiment.

According to the second embodiment, a phase difference arises between the light beam having passed through one light transmissive part 222 of the beam shaping optical system 205 and the light beam having passed through the other light transmissive part 223 thereof as mentioned above. As a result, when the laser light having passed through the beam shaping optical system 205 is collected with the objective lens 304, the light convergence points 224 and 225 as many as the light transmissive parts 222 and 223 having the phase difference are formed on the optical axis L of the objective lens 304 at an interval defined according to the wavelength of the laser light. By doing so, irradiation with the laser light can be simultaneously performed at different height positions of the specimen 20 on two cross-sections perpendicular to the optical axis L of the objective lens 304.

Moreover, since the spacing between both light convergence points 224 and 225 (distance between the centers of the light convergence points on the optical axis L) is a predetermined distance d, a region which spreads deeper in the optical axis direction can be stimulated.

Moreover, as mentioned above, the dimensions of the incident surfaces 222a and 223a of the first and second light transmissive parts 222 and 223 are so configured that the incident light amounts on the respective incident surfaces are equal to each other. Hence, the light amount of the laser light passing through the first light transmissive part 222 can be made equal to the light amount of the laser light passing through the second light transmissive part 223. As a result, the specimen 20 can be stimulated at the light convergence points 224 and 225 under the same conditions. Notably, when the light amount of the laser light is distributed according to a Gaussian distribution in the radial direction in the cross-section perpendicular to the optical axis, the dimensions of the incident surfaces 222a and 223a are needed to be so determined that the amounts of light incident on the first and second light transmissive parts 222 and 223 are equal to each other, multiplied by the ratio in the Gaussian distribution. When there is a difference between the light amounts for the first and second light transmissive parts 222 and 223, while the spacing between the two light convergence points 224 and 225 does not change, third and fourth light convergence points are formed outward the light convergence points 224 and 225 in the optical axis direction. Moreover, this also results in imbalance between the light amounts for the two light convergence points 224 and 225.

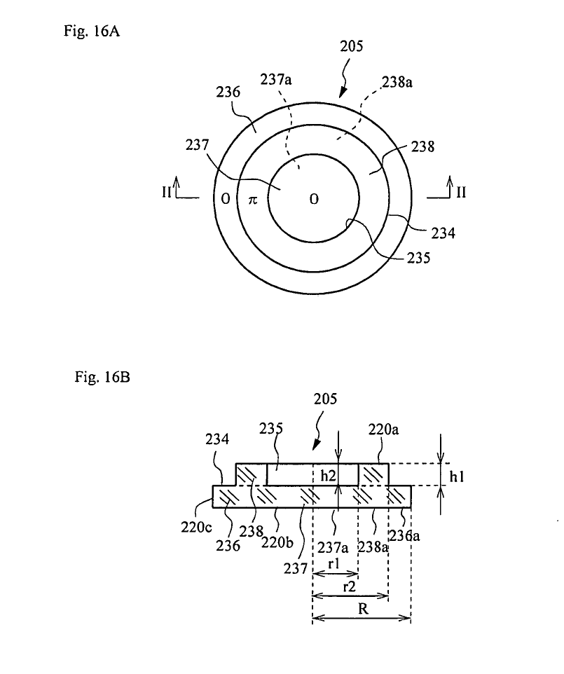

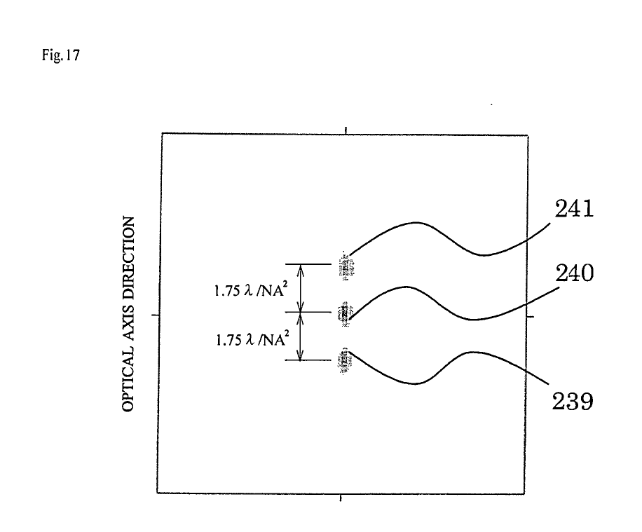

In the second embodiment, these two light convergence points 224 and 225 are exemplarily formed on the optical axis L. Three or more light convergence points instead may be formed on the optical axis L. For example, when three light convergence points are to be formed on the optical axis L, the beam shaping optical system 205 as illustrated in FIGS. 16A and 16B can be used.

In the example illustrated in FIG. 16, on the one surface 220a of this beam shaping optical system 205, a concave part 235 is formed in the center part of the beam shaping optical system 205, in addition to a step part 234 which is open to the circumferential surface 220c of the beam shaping optical system 205 and extending in the circumferential direction of the beam shaping optical system 205. The depth dimension h1 of the step part 234 and the depth dimension h2 of the concave part 235 are equal to each other. The depth dimensions h1 and h2 are configured to satisfy the relations h1·(n−1)=λ/2 and h2·(n−1)=λ/2, respectively. Forming the step part 234 and the concave part 235 allows a first light transmissive part 236 to be formed in the circumferential edge part of the beam shaping optical system 205, a second light transmissive part 237 which has a plate thickness dimension same as the plate thickness dimension of the first light transmissive part 236 to be formed in the center part thereof, and an annular third light transmissive part 238 which has a plate thickness dimension larger than the plate thickness dimensions of the first and second light transmissive parts 236 and 237 to be formed between these light transmissive parts.

Herein, areas of incident surfaces 236a, 237a and 238a of the first to third light transmissive parts 236, 237 and 238 are equal to one another. Namely, when the light amount of the laser light is uniform in the cross-section perpendicular to the optical axis, amounts of light passing through the first to third light transmissive parts 236, 237 and 238 are equal to one another.

Moreover, the areas of the incident surfaces are not necessarily equal to one another. Specifically, when the radius of the entire beam shaping optical system 205, that is, the radius of the outer circumference of the first light transmissive part 236 is R, the radius of the concave part 235, that is, the radius of the outer circumference of the second light transmissive part 237 is r1, and the radius of the outer circumference of the third light transmissive part 238 is r2, determining the dimensions of the first to third light transmissive parts 236, 237 and 238 so as to satisfy Expressions (10) and (11) below can increase the contrast more.

r1=17×R/25 (10)

r2=20×R/25 (11)

According to the example illustrated in FIG. 16, a phase difference π is given between the laser light having passed through the first light transmissive part 236 and the laser light having passed through the second light transmissive part 237. A phase difference n is given between the laser light having passed through the second light transmissive part 237 and the laser light having passed through the third light transmissive part 238. Notably, FIG. 16 exemplarily shows the phase differences “0”, “π” and “0”, which may be replaced conversely.

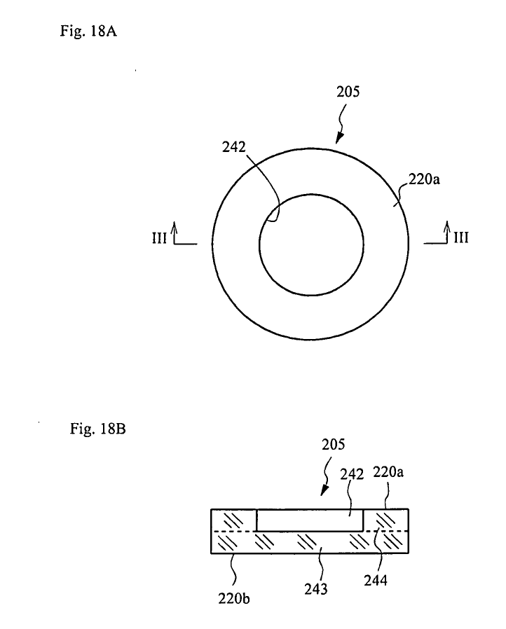

In this case, calculating a distribution of light intensity along the optical axis direction using Expression (8) mentioned above affords the result illustrated in FIG. 17. As apparent from FIG. 17, light convergence points 239, 240 and 241 whose values of light intensity are at their maximums present on the geometric optical focal point of the objective lens 304 and in front of and behind this focal point on the optical axis L. Namely, when the laser light having passed through the beam shaping optical system 205 illustrated in FIG. 16 passes through the objective lens 304, the three light convergence points 239, 240 and 241 whose values of light intensity are at their maximums can be formed on the optical axis L. Accordingly, the specimen 20 can be simultaneously irradiated with light beams at three different height positions thereof on three cross-sections perpendicular to the optical axis L of the objective lens 304, respectively. Notably, also in this case, the amounts of light passing through the first to third light transmissive parts 236, 237 and 238 of the beam shaping optical system 205 are equal to one another, as mentioned above. Hence, the light amounts at the three light convergence points 239, 240 and 241 are approximately equal to one another. Moreover, the light convergence points 239, 240 and 241 are also scanned by the second scanning unit 206.

Moreover, in the case of the beam shaping optical system 205 illustrated in FIG. 16, three light convergence points are not formed when the numerical aperture NA of the objective lens 304 is small. On the other hand, the spacings between neighboring two light convergence points of the three light convergence points 239, 240 and 241 are 1.75λ/NA² when NA is large. Herein, supposing the spacings between neighboring two light convergence points of the three light convergence points 239, 240 and 241 (distance between the centers of the light convergence points) as being d (in other words, spacings d between the three light convergence points 239, 240 and 241), the relationship of Expression (9) mentioned above is completed. The coefficient of proportionality A(NA) is the value 1.75 when NA is large, and a value between 1.75 and 4.6 when NA is medium. Hence, the range of the coefficient of proportionality A(NA) is 1.75≦A(NA)≦4.6.

Notably, the distance d does not exceed the distance between the centers of the light convergence points, 4.6λ/NA², which distance is in the case of two light convergence points. Accordingly, the distance 2d of the entire line connecting the light convergence points is represented by Expression (12) below, where the wavelength of the laser light is λ.

2d=2×A(NA)×λ/NA² (12)

Moreover, still in a case of four or more light convergence points, the distances between the centers of the light convergence points do not exceed the distance between the centers of the light convergence points, 4.6λ/NA², which distance is in the case of two light convergence points.

Naturally, when the light amount of the laser light exhibits a Gaussian distribution, the ratio in the Gaussian distribution is needed to be taken into consideration. Notably, also in the case of the configuration in FIG. 16, when there is a difference between the light amounts for the first to third light transmissive parts 236, 237 and 238, while the spacings between the first to third light convergence points 239, 240 and 241 do not change, fourth and fifth light convergence points are formed outward the light convergence points 239, 240 and 241 in the optical axis direction. Moreover, this also results in imbalance between the light amounts for the three light convergence points 239, 240 and 241.

As above, in the beam shaping optical system 205 according to the second embodiment, when a light beam diameter φ of the laser light from the second light source 201 is narrowed, NA of the laser light with which the specimen 20 is irradiated becomes small based on φ=2×f×NA where the focal distance of the objective lens 304 is f. In this case, the spacing between the light convergence points in the optical axis direction is proportional to NA of the laser light as apparent from Expressions (9) and (12) mentioned above. Hence, the spacing between the light convergence points is proportional to the light beam diameter of the laser light from the second light source 201. Namely, the light convergence region of the laser light spreading with the beam shaping optical system 205 (light convergence region spreading in the optical axis direction on the sides of the focal plane, as the center, of the objective lens 304) is proportional to the light beam diameter of the laser light from the second light source 201.

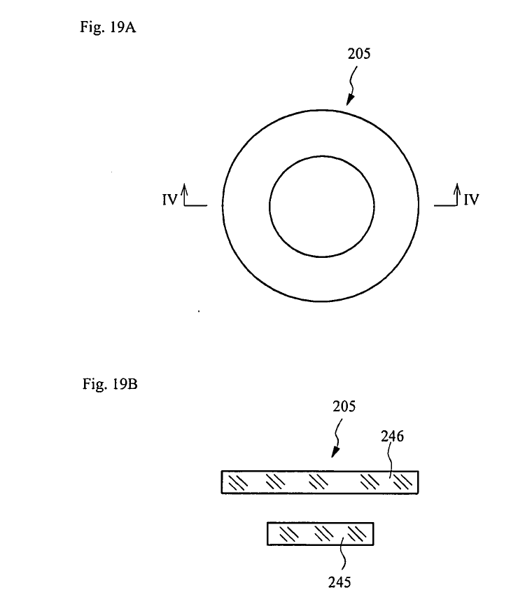

Moreover, in the example illustrated in FIGS. 12A and 12B, that forming the step part 221 in the circumferential edge part of the beam shaping optical system 205 allows the two light transmissive parts 222 and 223 different in plate thickness dimension to be formed in the beam shaping optical system 205 is exemplarily presented. Instead, for example, as illustrated in FIGS. 18A and 18B, a concave part 242 is formed on the one plane 220a of the beam shaping optical system 205 in its center part, and thereby, two light transmissive parts 243 and 244 with different plate thickness dimensions in the beam shaping optical system 205 can also be formed.

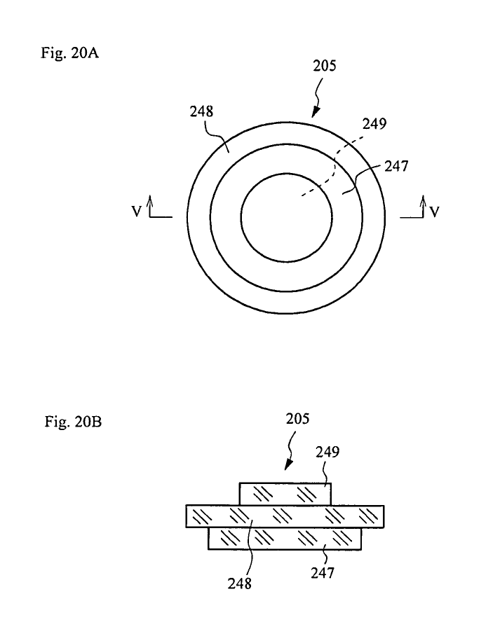

Moreover, in the description above, forming the step parts 221 or 234 and the concave part 235 in the beam shaping optical system 205 exemplarily represents the plurality of light transmissive parts 222 and 223 or 236, 237 and 238 with different plate thickness dimensions to be formed in the beam shaping optical system 205. Instead, a plurality of glass plates with different dimensions from one another can also be overlapped with one another to form a plurality of light transmissive parts with different plate thickness dimensions from one another in the beam shaping optical system 205. In this case, for example, as illustrated in FIGS. 19A and 19B, when two light transmissive parts are formed in the beam shaping optical system 205 in order to form two light convergence points, two glass plates 245 and 246 with different diameters from each other can also be disposed spaced between them.

Moreover, in this case, in the example illustrated in FIGS. 16A and 16B, in order to form the three light convergence points 239, 240 and 241 on the optical axis L, forming the step part 234 and the concave part 235 in the beam shaping optical system 205 to form the three light transmissive parts 236, 237 and 238 is exemplarily represented. Instead, for example, as illustrated in FIGS. 20A and 20B, three glass plates 247, 248 and 249 with different diameters from one another are overlapped with one another irrespective of their dimensions of the diameters, and thereby, three light transmissive parts can also be formed in the beam shaping optical system 205.

Notably, when the plurality of either glass plates 245 and 246 or 247, 248 and 249 are overlapped with one another as illustrated in either FIG. 19 or FIG. 20, glass plates with the same refractive power are preferable to be used.

Furthermore, in the examples illustrated above, the beam shaping optical system 205 is exemplarily represented to be disc-shaped. Instead, for example, as illustrated in FIGS. 21A and 21B, the beam shaping optical system 205 that is rectangular can also be used.

Notably, the beam shaping optical system 205 that gives a phase difference to the incident laser light using a glass plate is exemplarily described not to be limiting, whereas a so-called spatial light modulator element can be used which can arbitrarily give a phase difference by arbitrarily switching an optical light path length of the light for each light transmissive part.

The scanning microscope 10 according to the embodiment performs control, with the controller 40 which controls the above-mentioned glass plates for the beam shaping optical system 205 in regard to their switching control or controls the spatial light modulator element, in regard to their operation. Thereby, it can stimulate a desired region of the specimen 20 with the laser light. In this case, the dimension of the region on which the laser light from the second light source 201 is collected via the objective lens 304 is set in the controller 40 using the input unit 50. The controller 40 controls the above-mentioned actuator and beam expander 208 of the beam shaping optical system 205 in regard to their operation to thereby stimulate (illuminated) the region set in the controller 40. Notably, the control amounts in controlling the beam shaping optical system 205 in regard to its operation (for example, spacing between neighboring two light convergence points (distance d between the centers of the light convergence points)) may be calculated based on operations of the controller 40 using the expressions mentioned above, or for those, relationship between those is beforehand stored in the storage unit 70 as a table to be read out by the controller 40 as their values.

Based on Expressions (9) and (12) mentioned above, the distance ΔD of the entire line connecting the plurality of light convergence points is as in Expression (13) below, where the numerical aperture of the objective lens 304 is NA and the wavelength of the laser light is λ.

ΔD=(N−1)×A(NA)×λ/NA² (13)

In Expression (13), A(NA) is a coefficient of proportionality and a function of NA, N is the number of the light convergence points and the range of the coefficient of proportionality A(NA) is 1.5≦A(NA)·4.6.

For example, ΔD=1.20 μm when NA=0.9 and λ=488 nm.

On the other hand, when the beam expander allows the diameter of the beam incident on the objective lens 304 to be variable, the distance of the light convergence region for the stimulating light in the optical axis direction, in other words, the distance ΔDS of the region which has intensity 80% or more of the maximum intensity of the collected light in the optical axis direction is as in Expression (14) below, where the wavelength is λ.

$$\begin{matrix}[ Expression 9 ] & \\ Δ DS = \frac{λ}{2 ( 1 - \sqrt{1 - {NA}^{2}} )} & ( 14 )\end{matrix}$$

For example, ΔDS=0.43 μm when NA=0.9 and λ=488 nm.

Herein, when the above-mentioned distance ΔD of the entire line connecting the plurality of light convergence points is the maximum distance of the light convergence regions for the stimulating light, ΔD has the relationship in Expression (15) below.

$$\begin{matrix}[ Expression 10 ] & \\ Δ D > \frac{λ}{2 ( 1 - \sqrt{1 - {NA}^{2}} )} & ( 15 )\end{matrix}$$

Notably, when the objective lens 304 with immersion liquid is a liquid immersion objective lens, supposing that the refractive index of the immersion liquid is n, λ is needed to be replaced by λ/n and NA to be replaced by NA/n in Expressions (13) to (15) mentioned above.

Moreover, the limitations in the above-mentioned embodiments can be properly combined. Moreover, part of the constituents may be unused. Moreover, as far as is permitted by the law, all publications and disclosures of the US patents regarding the devices and the like cited in the above-mentioned embodiments and modified examples are incorporated herein by reference as a part of the description of the present specification.

### REFERENCE SIGNS LIST

10 Scanning microscope (microscope)
20 Specimen
40 Controller
50 Input unit
100 First scanning optical system (first optical system)
101 First light source
200 Second scanning optical system (second optical system)
201 Second light source
205 Beam shaping optical system
205a, 205b, 225a, 225b and 235a Conical lenses
215a and 215b Conical mirrors
235b Planar mirror
235c Hollow mirror (optical path switching member)
208 Beam expander
300 Imaging optical system
304 Objective lens

1-24. (canceled)

25. A microscope comprising:
a first optical system that irradiates a specimen with light from a first light source via an objective lens to receive light from the specimen; and
a second optical system that irradiates the specimen with the light from the first light source or light from a second light source different from the first light source via the objective lens so as to cause the specimen to express a specific phenomenon, wherein
the second optical system has a beam shaping optical system that shapes the light from the first light source or the light from the second light source such that a light convergence region on which the light from the first light source or the light from the second light source is collected via the objective lens is larger than a depth of focus of the objective lens.

26. The microscope according to claim 25, wherein
the beam shaping optical system shapes the light from the first light source or the light from the second light source such that the following condition is satisfied:
$$Δ D > \frac{λ}{2 ( 1 - \sqrt{1 - {NA}^{2}} )} \qquad [ Expression 11 ]$$
where
ΔD represents the maximum distance of the light convergence region of the light from the first light source or the light from the second light source,
λ represents the wavelength of the light from the first light source or the light from the second light source, and
NA represents the numerical aperture of the objective lens.

27. The microscope according to claim 25, wherein
the beam shaping optical system shapes the light such that the light from the first light source or the light from the second light source is collected via the objective lens to be two light beams which are apart from each other by a predetermined distance and form a predetermined angle relative to each other in a predetermined cross-section containing an optical axis of the second optical system.

28. The microscope according to claim 27, wherein
the beam shaping optical system shapes the light in regard to its shape in a plane perpendicular to the optical axis such that the light from the first light source or the light from the second light source passes through a region apart from the optical axis by a predetermined distance in a pupil of the objective lens to be collected via the objective lens.

29. The microscope according to claim 28, wherein
the beam shaping optical system shapes the light in regard to its shape in the plane perpendicular to the optical axis into an annular belt shape.

30. The microscope according to claim 29, wherein
the beam shaping optical system comprises two conical lenses arranged such that apexes of the conical lenses face each other.

31. The microscope according to claim 29, wherein
the beam shaping optical system comprises two conical lenses arranged such that apexes of the conical lenses are in reverse orientations to each other.

32. The microscope according to claim 29, wherein
the beam shaping optical system comprises a concave conical lens whose conical surface is formed into a mortar-like shape and a convex conical lens in which whose conical surface is disposed to face the conical surface.

33. The microscope according to claim 30, wherein
an outer diameter of the annular belt-shaped light is varied by varying a spacing between the conical lenses in an optical axis direction.

34. The microscope according to claim 29, wherein
the beam shaping optical system has a concave conical mirror on which a conical surface which reflects the light is formed into a mortar-like shape and in which a through hole is formed on the optical axis and a convex conical mirror on which a conical surface which reflects the light is formed and which is disposed such that its position is coordinated with a position of the through hole, and is configured to allow the light from the light source to pass through the through hole, to be reflected on the convex conical mirror, and furthermore, to be reflected on the concave conical mirror.

35. The microscope according to claim 34, wherein
an outer diameter of the annular belt-shaped light is varied by varying a spacing between the conical mirrors in an optical axis direction.

36. The microscope according to claim 29, wherein
the beam shaping optical system comprises a conical lens, a planar mirror that reflects the light having passed through the conical lens, and furthermore, allows it to incident on the conical lens, and an optical path switching member that guides the light from the light source to the conical lens and guides the light from the conical lens to the specimen, in this order from a light source side.

37. The microscope according to claim 36, wherein
an outer diameter of the annular belt-shaped light is varied by varying a spacing between the conical lens and the planar mirror in an optical axis direction.

38. The microscope according to claim 30, comprising
a beam expander that is disposed between the first light source or the second light source and the beam shaping optical system or between the beam shaping optical system and the objective lens, and varies an annular belt width of the annular belt-shaped light by varying a diameter of the light.

39. The microscope according to claim 25, wherein
the beam shaping optical system gives a phase difference between a part of any one of the light from the first light source and the light from the second light source and at least part of a rest of the light and forms a plurality of light convergence points on an optical axis of the objective lens via the objective lens.

40. The microscope according to claim 39, wherein
the beam shaping optical system has a plurality of light transmissive parts that allow the light to pass through and gives a phase difference between the light having passed through at least one light transmissive part of the light transmissive parts and the light having passed through the other light transmissive part.

41. The microscope according to claim 40, wherein
the beam shaping optical system is a plate-shaped member and is formed such that optical light path lengths of the light for the respective light transmissive parts are different from one another.

42. The microscope according to claim 40, wherein
the beam shaping optical system is a spatial light modulator element and optical light path lengths of the light for the respective light transmissive parts are arbitrarily switchable.

43. The microscope according to claim 41, wherein
the light transmissive parts have respective incident surfaces on which the light is incident and areas of the incident surfaces are configured such that incident light amounts on the respective incident surfaces are equal to one another.

44. The microscope according to claim 25, comprising:
an input unit that a dimension of the light convergence region on which the light is collected via the objective lens is inputted to; and
a controller that controls the beam shaping optical system in accordance with the dimension of the light convergence region.

45. The microscope according to claim 30, comprising:
an input unit that a dimension of the light convergence region on which the light is collected via the objective lens is inputted to; and
a controller that performs control of at least one of a conical lens position and a conical mirror position in accordance with the dimension of the light convergence region.

46. The microscope according to claim 37, comprising:
an input unit that a dimension of the light convergence region on which the light is collected via the objective lens is inputted to; and
a controller that performs control of a position of the conical lens and a position of the planar mirror in accordance with the dimension of the light convergence region.

47. The microscope according to claim 38, comprising:
an input unit that a dimension of the light convergence region on which the light is collected via the objective lens is inputted to; and
a controller that controls the beam expander in accordance with the dimension of the light convergence region.

48. The microscope according to claim 41, comprising:
an input unit that a dimension of the light convergence region on which the light is collected via the objective lens is inputted to; and
a controller that controls the plate-shaped member in regard to its switching or controls the spatial light modulator element in accordance with the dimension of the light convergence region.

49. A stimulating apparatus attached to a microscope including a light collecting optical system that irradiates a specimen with excitation light via an objective lens and collects fluorescence light generated from the specimen, the apparatus comprising:
a stimulating optical system that irradiates the specimen via the objective lens with light from a first light source that has radiated the excitation light or light from a second light source different from the first light source so as to cause the specimen to express a specific phenomenon, wherein
the stimulating optical system has a beam shaping optical system that shapes the light from the first light source or the light from the second light source such that a light convergence region on which the light from the first light source or the light from the second light source is collected via the objective lens satisfies the following condition:
$$Δ D > \frac{λ}{2 ( 1 - \sqrt{1 - {NA}^{2}} )} \qquad [ Expression 12 ]$$
where
ΔD represents the maximum distance of the light convergence region of the light from the first light source or the light from the second light source,
λ represents the wavelength of the light from the first light source or the light from the second light source, and
NA represents the numerical aperture of the objective lens.
